(19) United States
(12) Patent Application Publication
(10) Pub. No.: US 2008/0071875 A1
(43) Pub. Date: Mar. 20, 2008

(54) Systems and methods for multimedia messaging

(76) Inventors: Stephanie Koff, Pacific Palisades, CA (US); John Eyles, Kareela (AU)

Correspondence Address: MCANDREWS HELD & MALLOY, LTD, 500 WEST MADISON STREET, SUITE 3400, CHICAGO, IL, 60661, US

(21) Appl. No.: 11/894,086

(22) Filed: Aug. 20, 2007

Related U.S. Application Data
(60) Provisional application No. 60/823,022, filed on Aug. 21, 2006.

(51) Int. Cl. G06F 15/16

(52) U.S. Cl. 709/206

(57) ABSTRACT

Certain embodiments of the present invention provide systems and methods for multimedia messaging. Certain embodiments include authorizing user access for multimedia content messaging, selecting one or more recipients, providing multimedia content, creating a message addressed to the one or more recipients including the multimedia content, specifying a message mode for the message, and allowing review of the message by the one or more recipients based at least in part on the mode. Provided content may include recording multimedia content, purchasing multimedia content, and/or selecting previously-created multimedia content, for example. In certain embodiments, one or more recipients may be added to or invited to join a messaging group. In certain embodiments, a message appearance may be altered based the multimedia content, the mode and/or the one or more recipients, for example. In certain embodiments, a multimedia greeting associated with a user may be created.

### RELATED APPLICATIONS

The present application relates to, and claims priority from, U.S. Provisional Application No. 60/823,022, filed on Aug. 21, 2006, entitled “Systems and Methods for Multimedia Messaging,” which is herein incorporated by reference in its entirety.

### BACKGROUND OF THE INVENTION

The present invention generally relates to electronic messaging. More specifically, the present invention relates to user defined and organized multimedia content messaging.

Use of cellular phones, personal digital assistants, handheld computers, and other mobile devices has become quite prevalent in society. Messaging has become a common and convenient way to communicate with other people. However, current voicemail and email systems are limited in the types of messaging and data transmission that can occur. Current systems suffer from a lack of user control over destination and viewership in messages and greetings, as well as a lack of customization. Current messaging systems also fail to provide user defined and organized content. Furthermore, electronic or at-a-distance communication, as opposed to in-person communication, suffers from the impersonal nature of the communication.

### BRIEF SUMMARY OF THE INVENTION

Certain embodiments of the present invention provide systems and methods for multimedia content messaging. Certain embodiments provide a method for multimedia content messaging including the steps of authorizing user access for multimedia content messaging, selecting one or more recipients, providing multimedia content, creating a message addressed to the one or more recipients including the multimedia content, specifying a message mode for the message, and allowing review of the message by the one or more recipients based at least in part on the mode.

In certain embodiments, the method may also include recording multimedia content, purchasing multimedia content, and/or selecting previously-created multimedia content, for example. In certain embodiments, the method may include adding one or more recipients to a messaging group. In certain embodiments, the method may include inviting one or more recipients to join a messaging group.

In certain embodiments, message mode comprises standard, just for you, view n times, and/or no regrets, for example. In certain embodiments, the method further includes altering an appearance of the message based on at least one of the multimedia content, the mode and the one or more recipients. In certain embodiments, the method includes creating a multimedia greeting associated with a user. In certain embodiments, the method includes creating a multimedia greeting associated with an incoming caller. In certain embodiments, access to review the message is allowed by a phone number, a user identifier, and/or an internet protocol (“IP”) address, for example.

Certain embodiments provide a system for multimedia messaging. The system includes a client providing access to generate and review multimedia content messages. The system also includes a server facilitating retrieval and display of multimedia content for the multimedia content messages. Additionally, the system includes a datastore storing messages and multimedia content. In certain embodiments, the datastore may be incorporated in the server, for example.

Certain embodiments provide a computer readable medium having a set of instructions for execution on a computing device. The set of instructions includes an access routine authorizing user access to a message system for multimedia content messaging. The set of instructions also includes a message composition routine allowing a user to select one or more recipients for a message and provide multimedia content for the message, and to specify a message mode for the message. The message composition routine creates the message addressed to the one or more recipients including the multimedia content under the message mode. The set of instructions further comprises a message review routine allowing review of the message by the one or more recipients based at least in part on the mode. The mode restricts viewing and/or forwarding of the message and the multimedia content in the message.

### BRIEF DESCRIPTION OF THE INVENTION

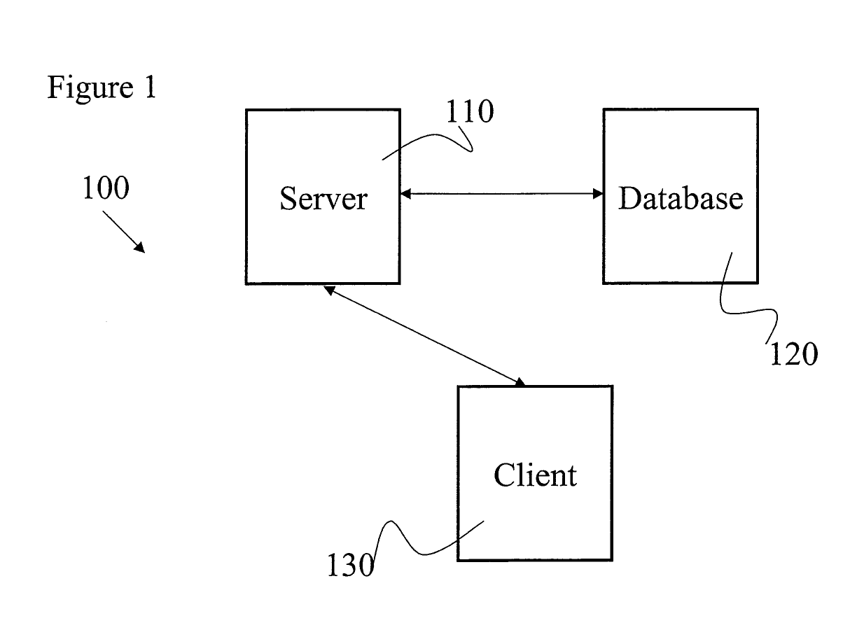

FIG. 1 illustrates a video messaging system in accordance with an embodiment of the present invention.

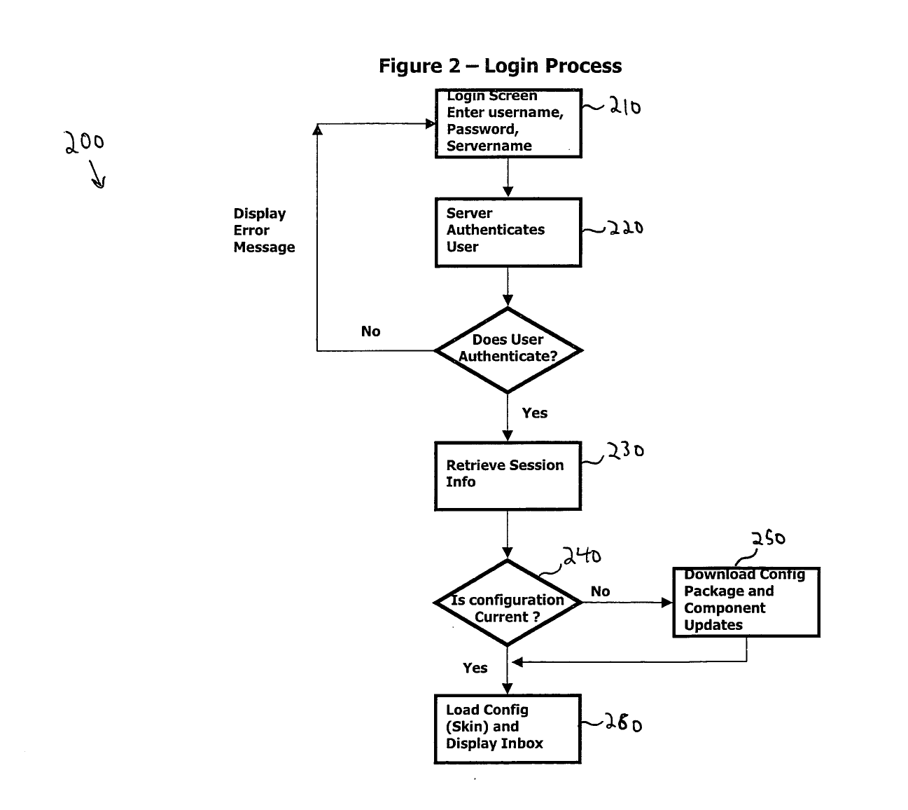

FIG. 2 illustrates a flow diagram for a method for accessing a video messaging account in accordance with an embodiment of the present invention.

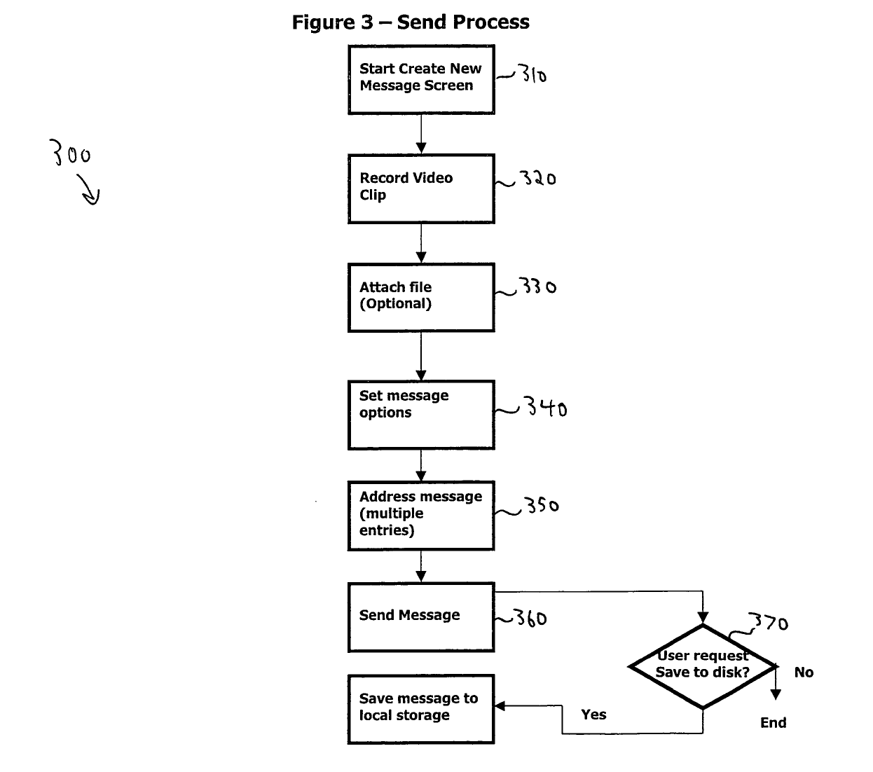

FIG. 3 illustrates a flow diagram for a method for creating and sending messages in accordance with an embodiment of the present invention.

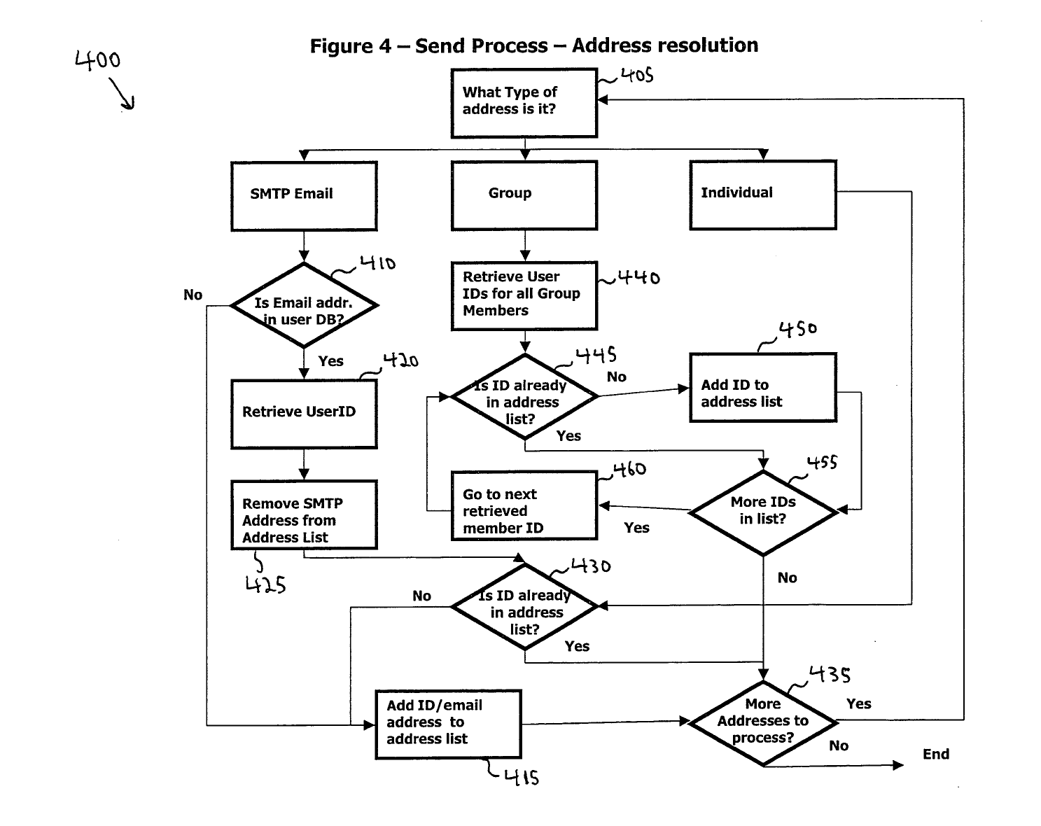

FIG. 4 illustrates a flow diagram for a method for address resolution in accordance a with an embodiment of the present invention.

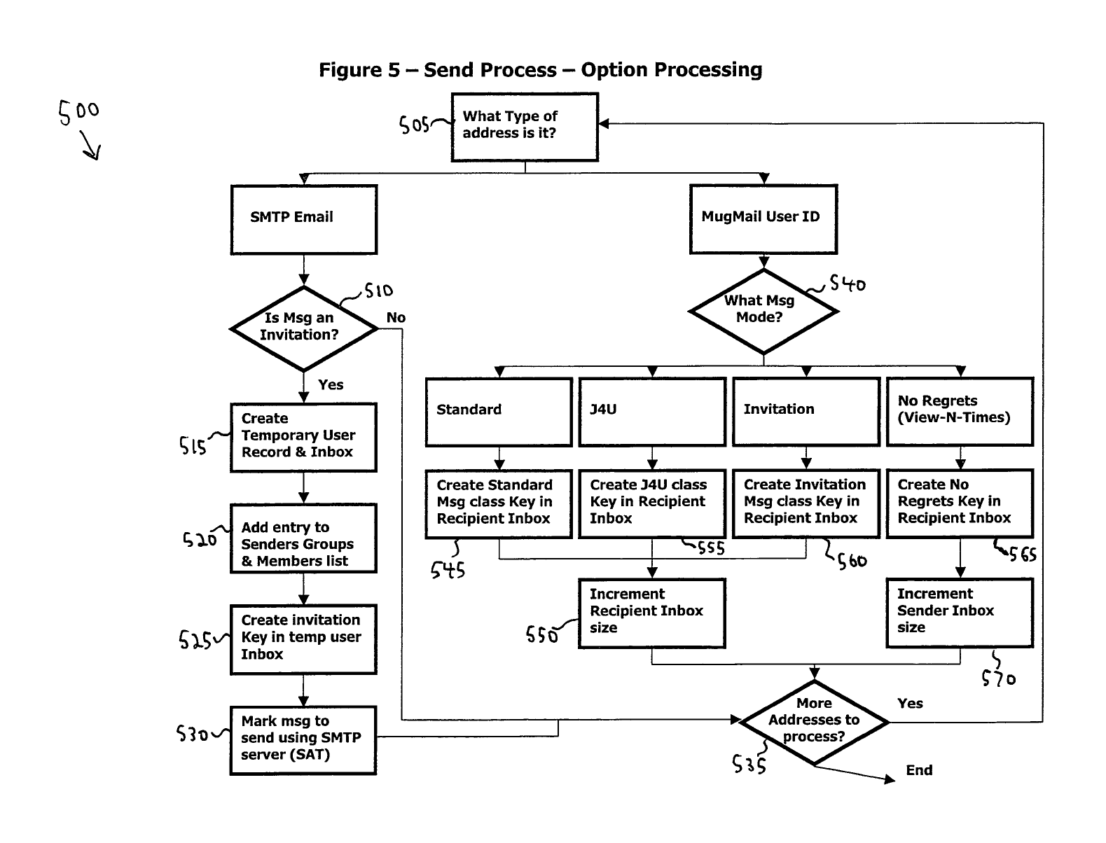

FIG. 5 illustrates a flow diagram for a method for option processing in accordance with an embodiment of the present invention.

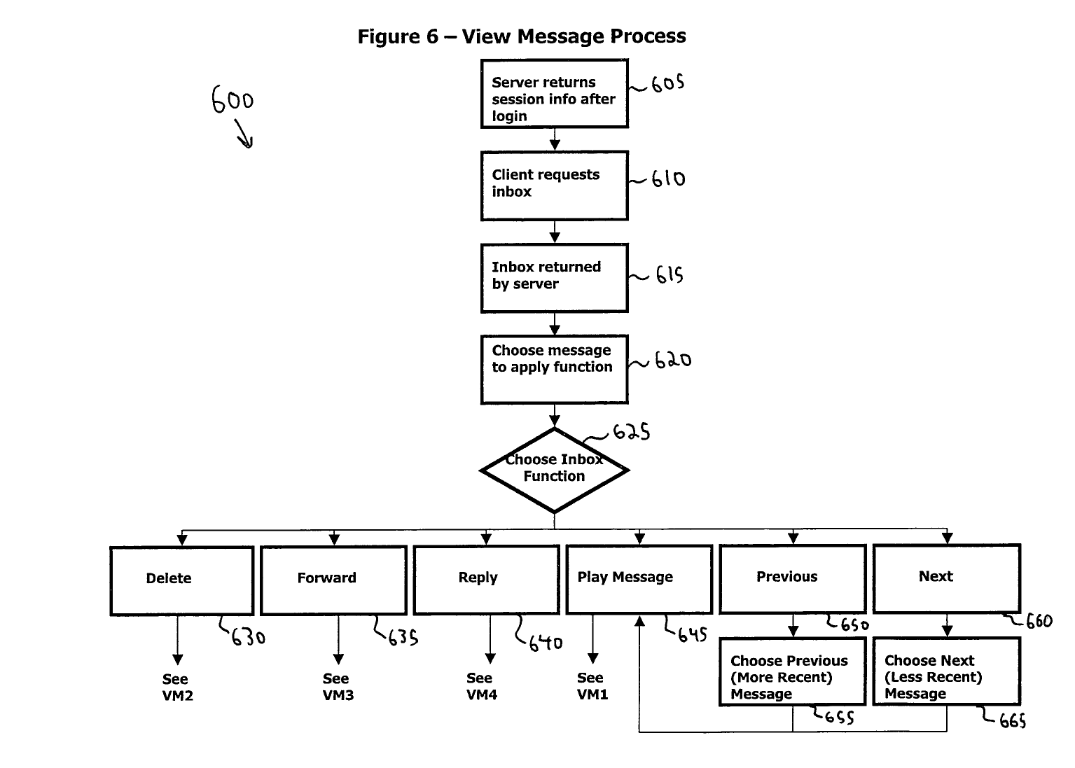

FIG. 6 illustrates a flow diagram for a method for message viewing in accordance with an embodiment of the present invention.

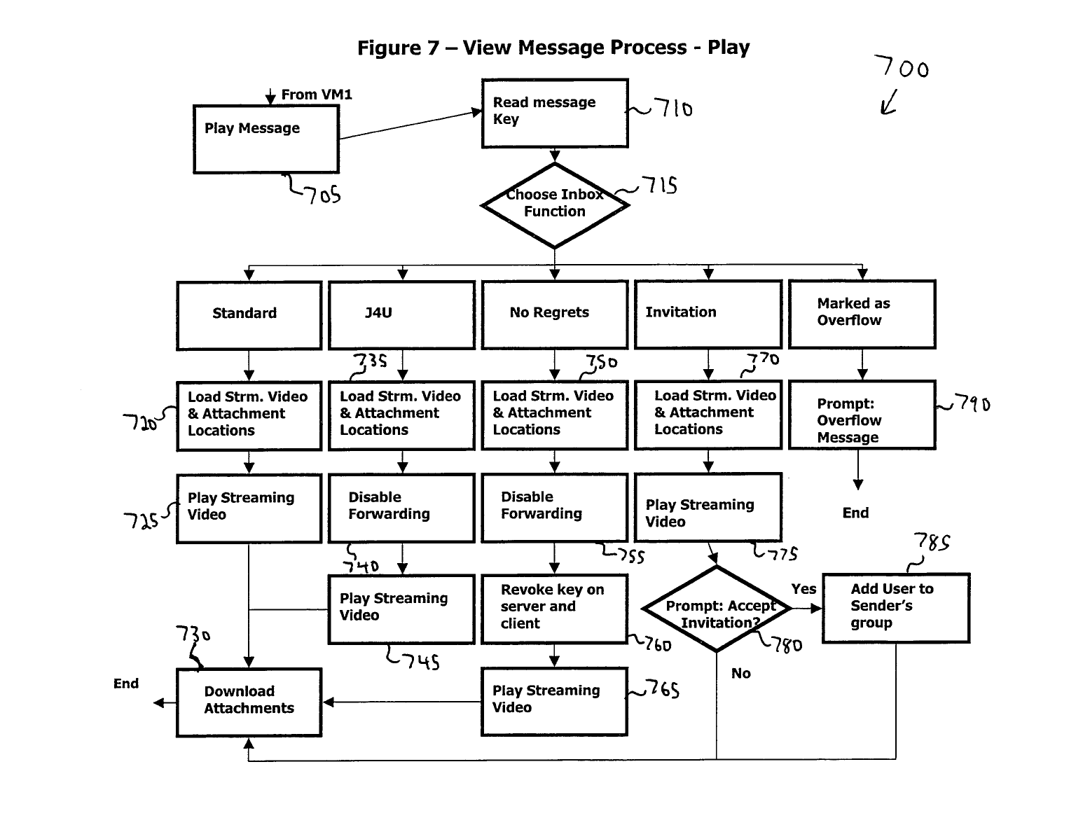

FIG. 7 illustrates a flow diagram for a method for playing a message in accordance with an embodiment of the present invention.

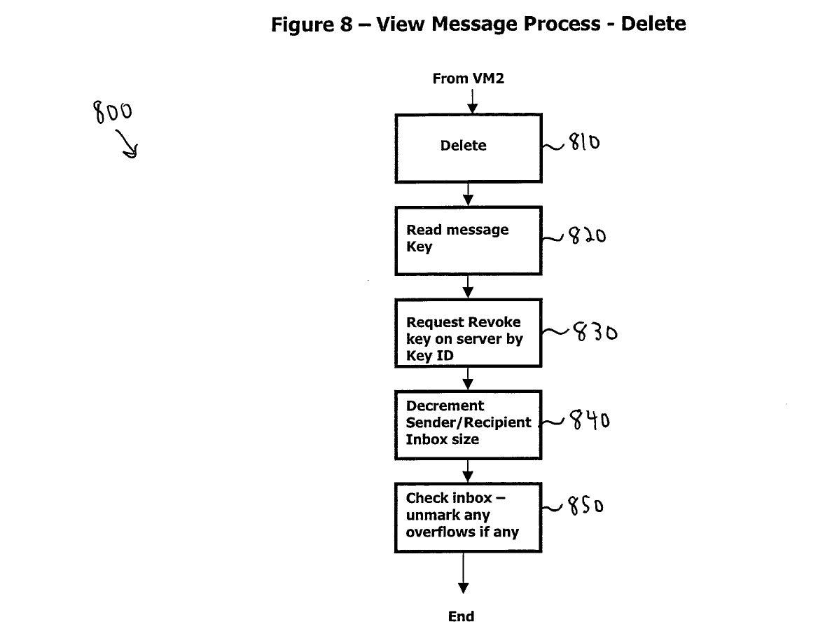

FIG. 8 illustrates a flow diagram for a method for deleting a message in accordance with an embodiment of the present invention.

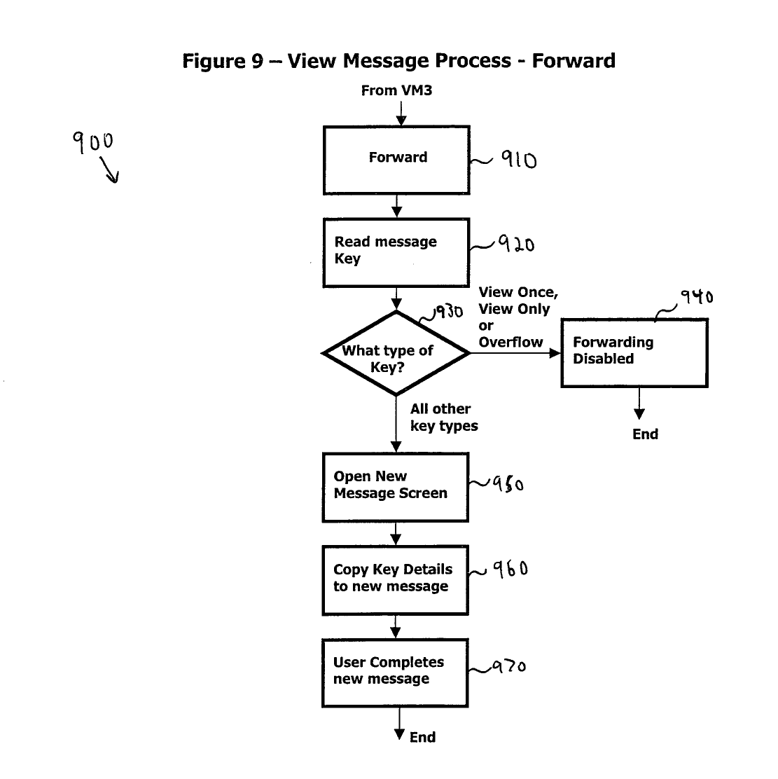

FIG. 9 illustrates a flow diagram for a method for forwarding a message in accordance with an embodiment of the present invention.

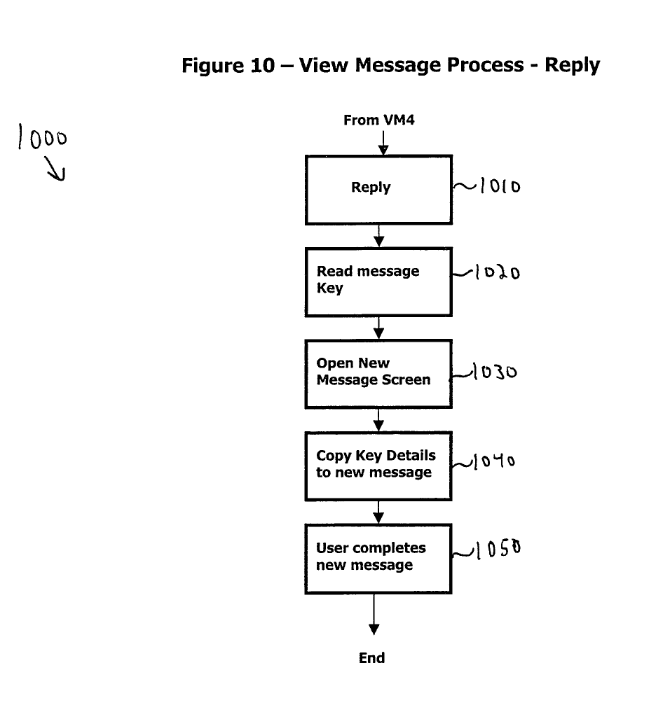

FIG. 10 illustrates a flow diagram for a method for replying to a message in accordance with an embodiment of the present invention.

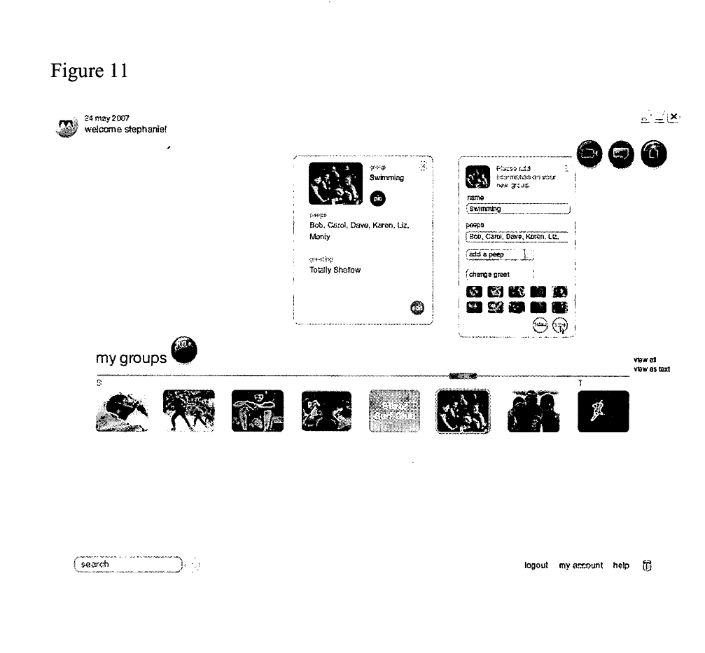

FIG. 11 illustrates an exemplary group management screen in accordance with an embodiment of the present invention.

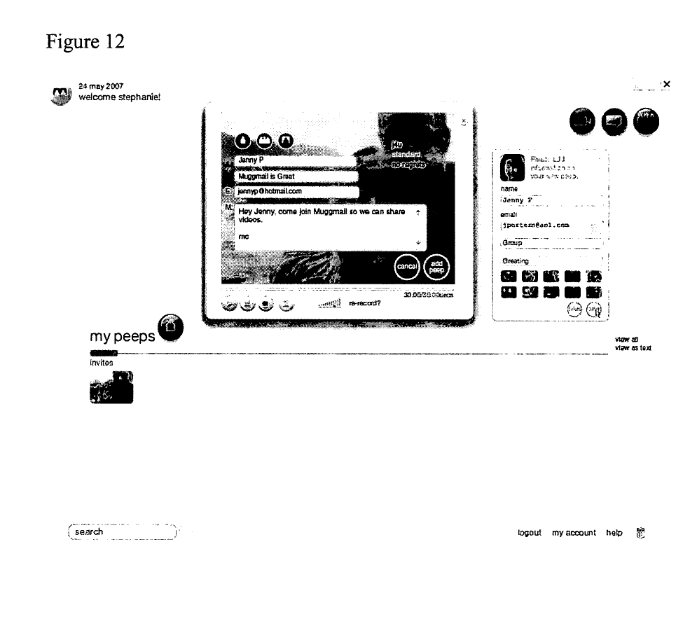

FIG. 12 shows an exemplary invitation screen in accordance with an embodiment of the present invention.

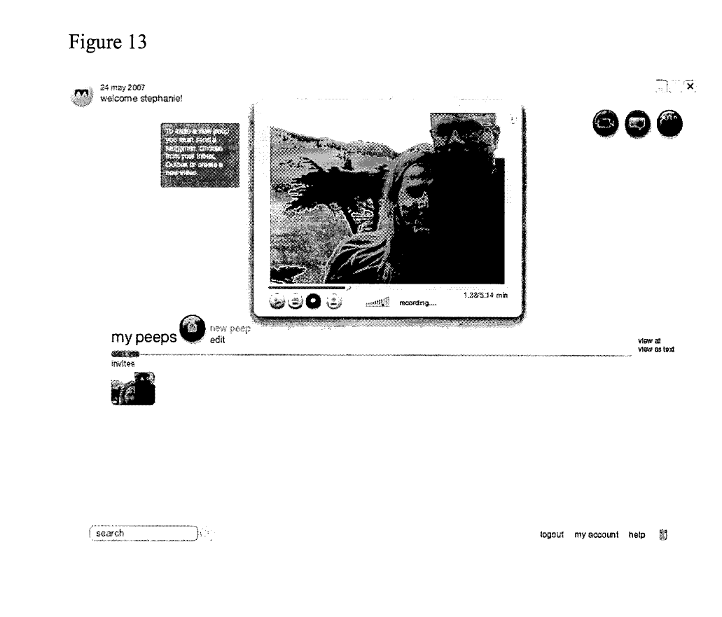

FIG. 13 depicts an exemplary video recording interface used with message

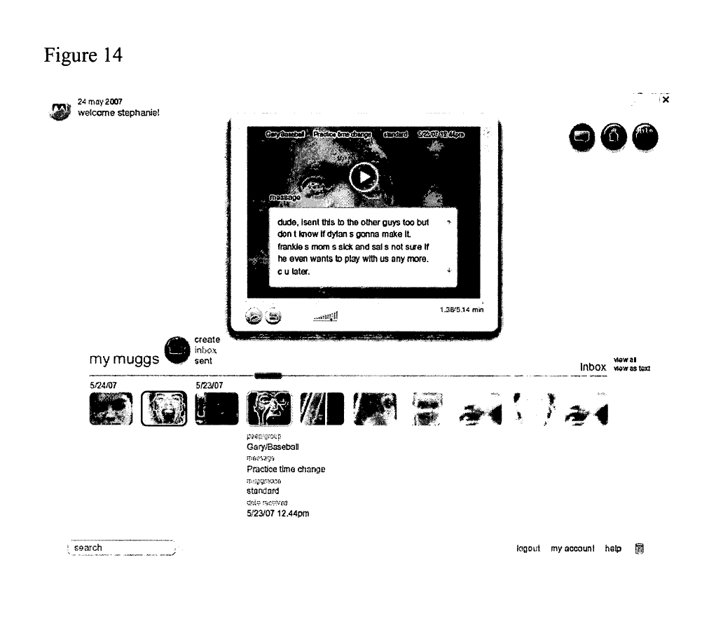

FIG. 14 and/or greeting composition in accordance with an embodiment of the present invention.

FIG. 14 shows an exemplary multimedia message viewable via one or more devices in connection with a user's messaging account in accordance with an embodiment of the present invention.

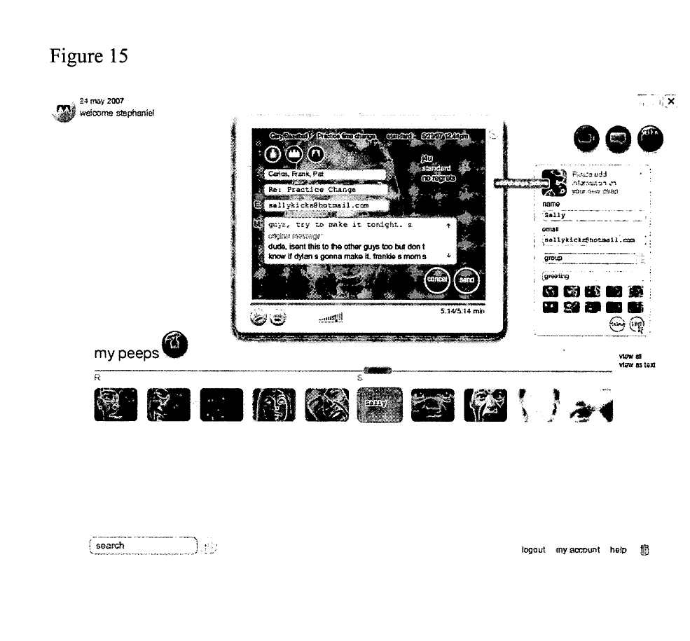

FIG. 15 depicts an exemplary interface for forwarding a multimedia message in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

FIG. 1 illustrates a video messaging system 100 in accordance with an embodiment of the present invention. The system 100 may be used in conjunction with a plurality of electronic devices, such as computers, cellular phones, personal digital assistants, handheld computers, tablet computers, mobile electronic devices, etc. The system 100 includes a server 110, a datastore 120, and a client 130. In certain embodiments, the server 110 includes a streaming video server and a web server. The server 110 may be implemented as a single server or as a plurality of servers in the system 100. In certain embodiments, the datastore 120 may be implemented as part of the server 110 and/or as a separate datastore 120. The datastore 120 may include one or more databases and/or other data stores. The client 130 may include and/or be implemented on one or more electronic devices, such as computers, cellular phones, personal digital assistants, handheld computers, tablet computers, mobile electronic devices, etc. The system 100 may include a plurality of clients 130 serviced by the server 110.

The server 110 maintains the master datastore 120 and hosts components that contain logic to manage the master datastore 120. The server 110 also hosts components that are able to stream video and multimedia content to client(s) 130.

The client 130 maintains a local copy of portions of the server datastore 120. After login and authentication, the local datastore is synchronized with the server datastore 120. The client 130 logs into the server 110 to send messages.

FIG. 2 illustrates a flow diagram for a method 200 for accessing a video messaging account in accordance with an embodiment of the present invention. At step 210, a user accesses a login screen or interface. The user enters a user name, password/passcode and possibly a server name via the login screen. In certain embodiments, settings may be saved in an initialization or configuration file and/or a registry, for example.

At step 220, the server 110 authenticates the user. The server 110 authenticates the user by verifying identification information, such as user name and password, against information stored in a datastore, memory or other storage. If the user is not authenticated, an error message may be displayed, and/or the user may be returned to the login screen, for example.

If user authentication is successful, then, at step 230, session information is retrieved. Session information includes user information (e.g., user id, name, etc.), account information (e.g., inbox size, number of messages, monetary balance, etc.), and/or skin/appearance configuration, for example.

At step 240, the skin or user interface configuration is checked to determine whether the configuration is up-to-date. At step 250, if the configuration is not up-to-date, a configuration package and/or component update(s) are downloaded. Downloading may occur automatically and/or as a result of user initiation. At step 260, if the configuration is current, then the skin configuration is loaded, and the user's inbox of messages is displayed.

FIG. 3 illustrates a flow diagram for a method 300 for creating and sending messages in accordance with an embodiment of the present invention. At step 310, a user accesses a create new message screen or new message creation functionality. At step 320, a video clip is recorded. At step 330, a file may be attached to the message. For example, a file may be selected from local and/or remote storage.

At step 340, message option(s) may be set. For example, message options may include sending a copy to an inbox, saving a message to disk, view only, view once, and/or view N times.

At step 350, the message is addressed. The message may be addressed to one or more recipients. Addressing options may include to an individual, to a group, to an email address, and/or send as an invitation, for example. Invitation information may include an email address, a relationship between sender and recipient, and a group to which to invite, for example.

At step 360, the message is sent. In certain embodiments, sending a message includes uploading streaming video to a content server, uploading any attachment(s) to the message, writing key(s) related to the message, etc. At step 370, if a user requested that the message be saved to disk, then the message is saved to local and/or remote storage. If no save was requested or configured, the send process ends.

FIG. 4 illustrates a flow diagram for a method 400 for address resolution in accordance with an embodiment of the present invention. At step 405, an address type is determined for a message being sent, such as the message being sent according to the method 300 described above. At step 410, if the message is an SMTP (Simple Mail Transfer Protocol) message and/or other similar message, for example, then the system determines if the recipient email address is found in a database, such as a user database. If the address is not in the database, then a user ID and/or email address is added to an address list at step 415. If the address is in the database, then the user ID for that address retrieved at step 420. At step 425, the SMTP address is then removed from the address list.

At step 430, the system determines whether the user ID is already in the address list. If not, then the user ID is added to the address list as recited in step 415. If so, then the system, at step 435, determines whether more addresses in the message are to be processed.

If the message is a group message, then, at step 440, user IDs for all members of the group are retrieved. At step 445, the first user ID of the group is reviewed to determine whether the ID is already in the address list. If not, at step 450, the ID is added to the address list. At step 455, the group is checked to determine whether more IDs are listed. If more IDs are present for the message, then, at step 460, the next retrieved group member ID is analyzed, as described above at step 445. Once all member IDs have been processed, then, at step 435, the system determines whether additional addresses are present to be processed.

If the message is an individual message, then, at step 430, as described above, the system determines whether the individual user ID is already in the address list. If the ID is in the list, then, the system checks whether more addresses are to be processed at step 435. If the ID is not in the list, then the ID is added to the address list at step 415. Then, at step 435, additional addresses are processed if applicable.

FIG. 5 illustrates a flow diagram for a method 500 for option processing in accordance with an embodiment of the present invention. At step 505, a type of address for a message to be sent is determined. If the message address is an SMTP email address, then, at step 510, the message is analyzed to determine if the message is an invitation. If the message is not an invitation, then the system proceeds to step 535 to determine whether more addresses for the message are to be processed. If the message is an invitation, then, at step 515, a temporary user record and inbox are created. At step 520, an entry is added to the message sender's groups and members list. At step 525, an invitation key is created in the temporary user inbox. At step 530, the message is marked to send using an SMTP server, for example (SMTP is used herein for the purposes of illustration only and other options may be used according to certain embodiments).

If the message address is a video messaging user ID, such as a MuggMail™ user ID, then, at step 540, a message mode is determined. At step 545, if the message mode is a standard mode, then, a standard message class key is created in a recipient's message inbox. At step 550, the recipient's inbox size is incremented. At step 555, if the message mode is J4U (“Just for you”) mode, then a J4U class key is created in the recipient's inbox. Then, at step 550, the recipient's inbox size is incremented. At step 560, if the message mode is an invitation mode, then, an invitation message class key is created in the recipient's inbox, and the recipient's inbox size is incremented at step 550. At step 565, if the message mode is a “no regrets” or view N times mode, then a no regrets key is created in the recipient's inbox. Then, at step 570, the sender's inbox size is incremented. As described above, at step 535, the system determines whether the message includes more addresses to process and potential repeats the method 500.

FIG. 6 illustrates a flow diagram for a method 600 for message viewing in accordance with an embodiment of the present invention. At step 605, a server returns session information after user login. For example, session information such as user ID, inbox limit, etc., may be retrieved. At step 610, a client requests a message inbox. At step 615, the inbox is returned by the server. At 620, a message is selected to which to apply an inbox function. Then, at step 625, an inbox function is selected. Functions include deleting a message (step 630), forwarding a message to another address (or addresses) (step 635), replying to a message (step 640), playing a message (step 645), moving to a previous message (step 650), moving to a next message (step 660), etc. If a user selects moving to a previous message at step 650, for example, then at step 655, the user may select which previous message to view. If a user selects moving to a next message at step 660, then, at step 665, the user may select which next message to view.

FIG. 7 illustrates a flow diagram for a method 700 for playing a message in accordance with an embodiment of the present invention. At step 705, message play is initiated. At step 710, a message key is read to identify a message type or mode. At step 715, an inbox function is chosen.

If a “standard” inbox function is selected, then, at step 720, streaming video and/or attachment locations are loaded. Alternatively, streaming video and/or attachment content may be loaded. Then, at step 725, streaming video for the message is played. At step 730, message attachment(s) may be downloaded.

If a “J4U” function is selected, then, at step 735, streaming video and/or attachment locations are loaded. Alternatively, streaming video and/or attachment content may be loaded. At step 740, message forwarding is disabled. At step 745, streaming video is played. At step 730, attachment(s) may be downloaded.

If a “No Regrets” function is selected, then, at step 750, streaming video and/or attachment locations are loaded. Alternatively, streaming video and/or attachment content may be loaded. At step 755, message forwarding is disabled. At step 760, the message key is revoked on the server and on the client. At step 765, streaming video is played. At step 730, any attachment(s) are downloaded.

If an “Invitation” function is selected, then, at step 770, streaming video and/or attachment locations are loaded. Alternatively, streaming video and/or attachment content may be loaded. At step 775, streaming video is played. At step 780, a user is prompted regarding acceptance of the invitation. If the user accepts, then, at step 785, the user is added to the sender's group. If the user does not accept, then, at step 730, attachment(s) to the message may be downloaded.

If a message is marked as “Overflow”, then at step 790, a user is prompted with an overflow message.

FIG. 8 illustrates a flow diagram for a method 800 for deleting a message in accordance with an embodiment of the present invention. At step 810, a message deletion is initiated. At step 820, a message key is read. At step 830, revocation of the key is requested on the server based on key ID. At step 840, sender and/or recipient inbox size is decremented. For example, the recipient inbox is decremented unless the message is a J4U message, in which case the sender inbox is decremented. At step 850, the user inbox is checked to unmark overflows. For example, if the deletion creates sufficient space in the inbox, message keys marked overflow in the inbox are unmarked to remove the overview and allow message viewing.

FIG. 9 illustrates a flow diagram for a method 900 for forwarding a message in accordance with an embodiment of the present invention. At step 910, a message forward is initiated. At step 920, a message key is read. At step 930, a type of message key is identified. For example, if the message key indicates “view once,” “view only” or “overflow,” then, at step 940, message forwarding is disabled. For other key types, at step 950, a new message screen is opened. At step 960, key details are copied from the message to a new message. For example, key details may include streaming video location, attachment location(s), sender name, comments/notes, etc. At step 970, the user completes the new message for sending. For example, the user may append new video, complete message addressing, append comments and/or notes, set options such as view once, etc.

FIG. 10 illustrates a flow diagram for a method 1000 for replying to a message in accordance with an embodiment of the present invention. At step 1010, a message reply is initiated. At step 1020, a message key is read. At step 1030, a new message screen is opened. At step 1040, key details are copied to a new message. For example, key details may include comments/notes, inserting the address of sender into the address list of the new message, etc. At step 1050, the user completes the new message for sending. For example, the user may append new video, complete message addressing, append comments and/or notes, set options such as view once, etc.

Certain embodiments provide a user defined video messaging software application that can be used in conjunction with computers, cellular phones, handheld electronic devices, and other mobile devices. A message (e.g., a MuggMail™) may be sent from a computer or a mobile device, for example. The streaming video messaging application allows the user to retain control over how the video message is read, manipulated, or disseminated.

Messages may be created and sent from a variety of devices including personal computers (PCs) and mobile devices, such as mobile phones. Additionally, users may create related identities for themselves on community websites, using multimedia content created or purchased by the user.

The messaging client enables a user to create his or her own streaming video using record control and video input from a camera, VCR, DVD or other source, or to choose pre-recorded and compressed video from a storage device, such as a hard drive, flash memory and/or other data storage. In certain embodiments, a user can take video and/or other multimedia content from any source and send the video and/or other multimedia content to his or her messaging account (e.g., a MuggMail™ count). Additionally, the user may opt to purchase video and other multimedia content from an online store accessible from the client application. Once the video and/or other multimedia content is in a user's account, the user can control distribution of the video and/or other multimedia content as if the user created it him or herself. For example, the user may limit the video and/or other multimedia content to viewing N times, viewing once, no forwarding, etc.

The messaging client allows several classes (“modes”) of streaming video messages to be created. For example, Standard, Just For You (J4U), View-N-Times and No Regrets, a special case of View-N-Times, messages may be created. Using modes, a user can control distribution of content even if the content is sent to others. Additionally, text (including rich text/html) and/or attachments can be added to a streaming video message.

To address a streaming video message, a user can choose recipient(s) from a secure groups and members list and/or enter standard SMTP and/or other email address(es). The groups and members list is a secure system to manage access to a messaging account by other people. A user adds a new member to a group by sending an invitation (a special class of streaming video message) to the non-user's SMTP and/or other email address. Using an Invitation, a non-user can register and download the messaging client, and/or join the invitee's selected group. In this fashion, messaging is spread to non-users, and current users can expand their groups and members list in a secure manner.

In certain embodiments, the messaging client may be dynamically branded (i.e. able to dynamically re-render its look and feel to reinforce a brand image or tell a story) using a technique called “server-directed skins”. The messaging client display or graphical user interface (GUI) may be dynamically configured based on criteria such as time, date, user demographics and account status.

In certain embodiments, server directed skins enable the look, feel and content (including software components) of the messaging client to be controlled and changed dynamically by the server. This enables the client to dynamically respond to a variety of events, including time, date, demographics of the caller and recipient, account status, etc. This enables dynamic branding and advertising, among other things. For example, if a user views a promotional streaming video message in their inbox, the message may cause the client to change its entire look to reinforce the brand introduced by the promotion. The skin may also cause the content of the client to change (messages added to the inbox, etc). Additionally, the skin may be used to display user specific information such as blog entries, photos and personal details in the messaging client. In certain embodiments, a server directed skin is different to a “normal skin” or user interface appearance in that it is controlled by the server, will automatically update files, content and software components to enable the skin, and/or is contextual to what the user is doing at that particular point in time, for example.

The client application is used to send messages to a server where the messages are stored. Access to the messages is managed by a system of keys, enabling the user to control how the messages are read after the messages are sent.

In certain embodiments, a message may include any of all of the following: a list of recipient(s), a list of attachment(s), one or more streaming or other video/media clips that may play sequentially or in an order selected by a user (sender and/or recipient), a title, a message mode (e.g., Standard, J4U, No Regrets, etc.), notes, comments and/or other text, etc. User defined messaging software allows users to determine how the video and other content in the system are managed. For example, secure groups, invitations and/or message modes (e.g., invite, standard, j4u, no regrets, etc.) may be used to allow a user to manage messaging.

A message recipient receives a message by calling and/or electronically accessing a server to which the message has been sent by the sender. The server adds the message to the recipient's inbox by providing the recipient a key to the message. The key is a security feature allowing a user access to a streaming video message, greeting or streaming video in the messaging system. When a user, for example, requests his or her inbox, the server searches for all of the keys associated with that particular user and then displays the corresponding streaming video message(s) for each key in the user's inbox. The user now has access to the streaming video and content associated with each key. There are four classes of keys, for example, associated with four modes of streaming video message—No Regrets, J4U, View-N-Times and Standard. A key may also be marked as overflow if the message causes the inbox size to be greater than an inbox size limit.

A No Regrets message is a class of message where the key to the message is immediately revoked when the message is viewed. Thus, a recipient to a No Regrets message can only view the message once. After viewing, the message does not appear in the recipient's inbox.

A J4U message is a class of message where the key to the message disallows an attempt by the user to forward or resend that message to another user. The user may view the message as many times as he or she chooses.

A View-N-Times message is a class of message where the key to the message disallows an attempt by the user to forward or resend that message to another user. In addition, the key decrements each time it is accessed, and, after N views, the key is revoked and the message does not appear in the recipient's inbox.

A Standard message is a class of message where the key to the message does not have any viewing restrictions. A Standard class streaming video message may be viewed any number of times or forwarded to another user.

An Invitation message is a special class of streaming video message designed to be delivered to a recipient's SMTP and/or other email address. An Invitation may be viewed without special messaging software and enables the recipient to register for messaging. The sender may also use an Invitation to invite a new user or an existing user to join a secure group. Invitations enable messaging to spread to new users. Additionally, in certain embodiments, invitations may appear within a recipient's inbox if the recipient is already a registered user and has used the email address given by the sender when the recipient registered for an account.

Secure groups allow messaging users to manage and control the distribution of their multimedia content. In certain embodiments, the groups and members list is a secure, directory-like subsystem that allows a messaging user to retain control over who is able to send messages to the user's inbox. In certain embodiments, each user in a group can “see” the group in his or her groups and members list, and also see all of the other group members. Any user can message with any other user that appears in their groups and members list. In certain embodiments, group lists are customized by individual users and appear as a group lists for those particular users. For example, a user may build a group list out of members in his or her directory, but the other users in that list do not see the same group list in their accounts unless they build the same list on their own.

In certain embodiments, the groups and members list is a closed and secure list, and the individual user retains control over whether he or she is part of a group or not. In addition, users are able to address messages to an entire group, as well as to individuals. The messages, whether sent to individual inboxes or posted to a group, are able to be viewed only by the individuals or group members designated by the user who created the message. Further, a user can assign a greeting to a user or to a group.

In certain embodiments, individual users control whether or not they are part of a certain group. In certain embodiments, individual users have control over whether or not other users/members are a part of their group (e.g., group lists can be edited).

Greetings allow a user to post a streaming video message to his or her groups and members list that any other user in the groups and members list can view. Greetings may be user specific. For example, if User(B) plays User(A)'s greeting, User(B) may view a different greeting than if User(C) plays User(A)'s greeting. Greetings may also be group specific. For example, a user may post a greeting that plays if the viewing user belongs to a specific group. In certain embodiments, a user-specific greeting has precedence over a group-specific greeting, and a default greeting may be specified to play for all other viewing users that do not have user-specific or group-specific greetings associated with them. A greeting can carry a variety of messages. For example, greetings may include company information and/or a personal message (such as “I am away on vacation”) that is designated for one member on a user's call list, more than one member on a user's call list, members in a group, members in more than one group, and/or all groups and members. Also, a user may opt to use a pre-recorded greeting, such as a “Celebrity Greeting”, instead of creating a greeting. Greetings allow a user to personalize his or her message or make a statement. Greetings can also be used as an outgoing message to inform a caller of some event.

In certain embodiments, the messaging system supports server directed skins. Server directed skins enable a look, feel and/or content (including software components) of the client to be controlled and changed dynamically by the server. Changing skins or appearance enables the client to dynamically respond to a variety of events, including time, date, demographics of the caller and recipient, account status, etc. Changing skins enables dynamic branding and advertising. For example, if a user views a promotional streaming video message in his or her inbox, the promotional message may cause the client to change its entire look to reinforce the brand introduced by the promotion. The message may also cause the content of the client to change (messages added to the inbox, etc). A server directed skin is controlled by the server and will automatically update files, content and software components to enable the skin. Alternatively and/or in addition, a user may configure the “skin” or appearance of the messaging client based on certain preferences.

For example, a person may receive an invitation, such as a MuggMail™ invitation, from a friend, or may have been introduced to multimedia messaging by word of mouth or through a community website. An invitation is a way for a person to join a group (and also sign up for messaging service if the person is not already a user). Invitations arrive via regular email, for example. A person may use an invitation and/or visit website to download or access the messaging client and sign up for the messaging service. Upon signing up, a user is automatically part of his or her own default group and any other group the user may have accepted through an invitation. In certain embodiments, only members of a group can transmit multimedia messages to each other.

Next, a user may elect to create more groups, manage existing groups, or start sending Invitations to those they want to communicate with. For example, FIG. 11 illustrates an exemplary group management screen. An invitation can be sent to anyone with an email address. For example, FIG. 12 shows an exemplary invitation screen. In certain embodiments, invitations may be sent to users who already have a messaging account.

A user may create his or her own multimedia messages by recording video and audio using a PC video camera or webcam, for example. For example, FIG. 13 depicts an exemplary video recording interface used with message and/or greeting composition. Text content and attachments can also be added to a message. The user may also elect to set the message mode to “just for you” or “no regrets” to further restrict the content of the message within the secure group environment. A user can create any number of messages, and then click the send button to deliver them. A message may be addressed to a user, a group, and/or an email address (in which case the message automatically shows up as an invitation). Messages may also be sent and viewed from mobile devices, such as a cell phone, depending on the device and the service to which the user has subscribed.

FIG. 14 shows an exemplary multimedia message viewable via one or more devices in connection with a user's messaging account. FIG. 15 depicts an exemplary interface for forwarding a multimedia message according to an embodiment of the present invention.

A user may also elect to set up one or more greetings. A greeting is specific to the sender and receiver. In other words, for any one person, a greeting may be different depending on what other person views it. A greeting can be set at an individual, group or default level. Greetings can contain all of the content a message does (e.g., audio, video, text and/or attachments). Greetings have meaning for the individual who sets the greeting, how the person views himself or herself, and/or how the person views his or her relationship with the person watching the greeting. A greeting can be viewed by clicking on an individual or group name in the groups and members list and/or by clicking on a link on a community website. Group security may extend to links on community websites. Some greetings and messages may also be viewable through instant messengers and podcasts. Message and greeting content can be created by a user. Celebrity and/or other content can be purchased on participating websites by an individual to use as a greeting or message.

Thus, certain embodiments provide user defined and organized video messaging software for communication systems operating on computers, cell phones, websites, etc., for a caller/sender and one or more recipients of the caller/sender. A caller may be defined as an individual with a phone number or IP address seeking to contact another individual (the recipient) with a phone number or IP address. Both callers and recipient are considered “Users.”

Certain embodiments provide an ability to create original multimedia files (i.e. video and/or audio). Files may be used as greetings for use by recipients and/or messages created by callers and left for recipients after receiving a greeting, for example. Files may be sent to users in a number of modes including but not limited to 1-time view only, n-times view and non-forwarding. Files may be created on any device and sent to any other device including but not limited to from a cell phone to a computer, from a cell phone to a cell phone, from a computer to a cell phone, etc.

Certain embodiments provide an ability to manage media files, such as by defining groups. Groups may include one or more lists of contacts for which greetings are associated and/or video messages are delivered. Contacts/addresses are associated with one or more groups. Groups include one or more addresses. A user may create and manage one or more groups through the messaging system.

Certain embodiments allow users to import multimedia content and control distribution of original and/or imported multimedia content is transmitted to others via the multimedia messaging software.

Certain embodiments provide a video messaging software platform designed to work within an existing operating system (such as a Microsoft Windows or Macintosh operating system) and over an existing network (such as Verizon, AT&T, etc.). In certain embodiments, software resides on a server with components on a user device (such as a computer, cell phone, etc.) for server-to-operating system communication. Software includes a record control enabling users to create their own video messages and greetings. Software enables access to greetings after purchase or download. Greetings created or purchased reside on a central server or set of servers to be accessed by IP address or phone number, for example. Software enables media file management, including association of media files with groups within contact lists, for example. Once a greeting is associated with a group, software enables delivery of that greeting to a group caller, should the recipient not answer the call. Software enables the caller to then leave a message, video and/or audio, for the recipient. Software enables a recipient to access messages left by callers.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the invention are described in the general context of method steps which may be implemented in certain embodiments by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represents examples of corresponding acts for implementing the functions described in such steps.

For example, certain embodiments may be implemented in a computer readable medium having a set of instructions for execution on a computing device. The set of instructions includes an access routine authorizing user access to a message system for multimedia content messaging. The set of instructions also includes a message composition routine allowing a user to select one or more recipients for a message and provide multimedia content for the message, and to specify a message mode for the message. The message composition routine creates the message addressed to the one or more recipients including the multimedia content under the message mode. The set of instructions further comprises a message review routine allowing review of the message by the one or more recipients based at least in part on the mode. The mode restricts viewing and/or forwarding of the message and the multimedia content in the message.

Embodiments of the present invention may be practiced in a networked environment using logical connections to one or more remote gaming terminals and/or other computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for multimedia content messaging, said method comprising:
authorizing user access to a messaging system for multimedia content messaging;
selecting one or more recipients for a multimedia message;
providing multimedia content for said multimedia message;
creating said message addressed to said one or more recipients including said multimedia content;
specifying a message mode for said message; and
allowing review of said message by said one or more recipients based at least in part on said mode.

2. The method of claim 1, wherein said providing step further comprises at least one of recording multimedia content, purchasing multimedia content, and selecting previously-created multimedia content.

3. The method of claim 1, further comprising adding one or more recipients to a messaging group.

4. The method of claim 1, further comprising inviting one or more recipients to join a messaging group.

5. The method of claim 1, further comprising controlling distribution of said multimedia content in said message by restricting viewing and forwarding of said message based on a message mode.

6. The method of claim 5, wherein said message mode comprises at least one of standard, just for you, view n times, and no regrets.

7. The method of claim 1, further comprising altering an appearance of said message based on at least one of said multimedia content, said mode and said one or more recipients.

8. The method of claim 1, further comprising altering a look, feel, and content of a message interface for reviewing a message based on message server content and at least one event associated with the message being reviewed.

9. The method of claim 1, further comprising creating a multimedia greeting associated with a user.

10. The method of claim 1, further comprising creating a multimedia greeting associated with an incoming caller.

11. The method of claim 10, further comprising selecting from among a plurality of multimedia greetings to associate with said incoming caller.

12. The method of claim 1, wherein said allowing step further comprises allowing access to review said message by at least one of a phone number, a user identifier, and an internet protocol (“IP”) address.

13. A system for multimedia messaging, said system comprising:
a client providing access to generate and review multimedia content messages;
a server facilitating retrieval and display of multimedia content for said multimedia content messages; and
a datastore storing messages and multimedia content.

14. The system of claim 13, wherein said datastore is incorporated in said server.

15. The system of claim 13, wherein said client comprises an interface for reviewing and generating multimedia content messages.

16. The system of claim 15, wherein said interface further comprises an adaptive interface, wherein an appearance and content of said interface are altered by said server based on at least one event with respect to a multimedia content message being reviewed.

17. The system of claim 13, wherein said client facilitates adding one or more recipients to a messaging group.

18. The system of claim 13, wherein said client facilitates inviting one or more recipients to join a messaging group.

19. The system of claim 13, wherein said client creates a multimedia greeting associated with an incoming caller by specifying one of a plurality of multimedia greetings to associate with said incoming caller.

20. A computer readable medium having a set of instructions for execution on a computing device, said set of instructions comprising:
an access routine authorizing user access to a message system for multimedia content messaging;
a message composition routine allowing a user to select one or more recipients for a message and provide multimedia content for said message, and specify a message mode for said message, the message composition routine creating said message addressed to said one or more recipients including said multimedia content under said message mode; and
a message review routine allowing review of said message by said one or more recipients based at least in part on said mode, wherein said mode restricts viewing and/or forwarding of said message and said multimedia content in said message.
